(19) United States
(12) Patent Application Publication
(10) Pub. No.: US 2015/0067503 A1
(43) Pub. Date: Mar. 5, 2015

(54) SYSTEM AND METHOD FOR VIRTUAL ASSISTANTS WITH AGENT STORE

(71) Applicant: PERSAIS, LLC, MESA, AZ (US)

(72) Inventors: Michael H. Slayton, Tempe, AZ (US); Vadim Kouklev, Tempe, AZ (US)

(21) Appl. No.: 14/470,678

(22) Filed: Aug. 27, 2014

Related U.S. Application Data
(60) Provisional application No. 61/870,851, filed on Aug. 28, 2013.
(60) Provisional application No. 61/870,754, filed on Aug. 27, 2013.

(51) Int. Cl. G06F 3/0484

(52) U.S. Cl. CPC G06F 3/0484
USPC 715/708

(57) ABSTRACT

A virtual assistant platform (“VAP”) provides a self-supporting and expandable architectural framework for virtual assistants (“VAs”) to communicate with a user via an electronic device. VAs may communicate with other devices, software programs, and other VAs. VAs may include intelligent agents configured to perform particular tasks. The VAP may include an execution environment that provides an interface between the VA and the electronic device and a framework of services for the intelligent agents. A VA may participate in or coordinate a group of VAs in which knowledge and tasks can be shared and cooperatively executed. The execution environment may include an agent store for registering agents for use on the VAP, storing agent code and data, and distributing agents to requesting users. Through the agent store, new VAs and agents may be distributed to users to expand their use of the VAP.

### CROSS-REFERENCE TO RELATED APPLICATIONS

This application is a non-provisional and claims the benefit of U.S. Pat. App. Ser. Nos. 61/870,751 and 61/870,754, both filed Aug. 27, 2013, and incorporated herein by reference.

### STATEMENT REGARDING FEDERALLY SPONSORED RESEARCH OR DEVELOPMENT

Not applicable.

### BACKGROUND OF THE INVENTION

The subject matter disclosed herein relates generally to intelligent agent communication systems and methods, and, more particularly, to computer-implemented intelligent agent systems and methods that provide electronic assistance to users for completing particular tasks.

Artificial intelligence systems have been implemented in many environments for the purpose of helping a person obtain or manage information. Examples include: an automated online assistant, used to provide customer service or other assistance electronically without the presence of a human agent; electronic bots for searching the internet, performing stock trades or other financial transactions, or simulating crowd responses; an artificial neural network for modeling relationships between inputs and outputs; and an intelligent personal assistant that receives input from a user and performs tasks based on the input in an attempt to produce useful output. One example of the intelligent personal assistant is SIRI by APPLE Inc. SIRI is a software application resident on most APPLE mobile devices that receives natural language input spoken by the user, parses the input, requests feedback from resources, such as dedicated servers or webpages generally available on the Internet, and reports the information gained from the dedicated servers or webpages back to the user. Also, SIRI is capable of performing some limited tasks within the capabilities of the mobile device, such as setting an alarm at a specified time or identifying a received message. In this regard, SIRI is capable of converting text to speech and vice versa, search the internet, answer questions, modify the user's appointment calendar, search for nearby establishments based on the device's location, and perform other similar tasks.

While SIRI has proven to be a useful personal assistant, it is limited to performing only native functions within the APPLE iOS and the device on which it is implemented, including a limited subset of web services. The native functions do not provide assistance for a wide variety of common problems in which a virtual assistant is needed. These problems include management of documents across multiple platforms and formats, management of multiple digital devices, access to cloud storage and processing, and access to knowledge stores for specific topics. Another drawback of SIRI and similar device-specific personal assistants is that the personal assistant software is not expandable or customizable. A user cannot add functionality to SIRI at will.

It would, therefore, be desirable to provide systems and methods that implement a virtual assistant platform for virtual assistants that can provide a more robust and customizable set of functionalities and capabilities.

### BRIEF DESCRIPTION OF THE INVENTION

The present invention overcomes the aforementioned drawbacks by providing systems and methods that provide electronic assistance to a user. In particular, a virtual assistant platform is configured to provide shared capabilities to a plurality of virtual assistants, allowing the virtual assistants to communicate with each other and variety of external services (web, software or hardware based), share data, learn from users, teach users using knowledge learned, and improve the knowledge and rules available to the platform. The user can access an agent store to download or stream additional specially-configured virtual assistants or agents and associated data to perform desired tasks or otherwise add desired functionality to the virtual assistant platform.

In accordance with one embodiment of the invention, a method is provided for providing electronic assistance to a user. The method includes providing a virtual assistant platform configured to share data across a plurality of virtual assistants, activating a first agent in one of the virtual assistants, the first agent located on a device client installed on a device of the user, and the first agent being configured to perform one or more tasks, and activating a second agent in the same or another of the virtual assistants, the second agent located on the device of the user or another device and facilitating communication with the first agent. The method may further include configuring the first agent and second agent to access one or more shared data stores, the shared data stores providing the virtual assistants with shared capabilities. One or more of the shared data stores may include a world ontology understood by all of the virtual assistants.

The first agent may be a main agent configured to manage tasks of one or more other agents on the device, and the method may further include activating at least one of the other agents on the device. At least one of the other agents on the device may be an adapter agent configured to communicate with an object. The method may further include providing an agent bus configured to deliver only communications between the main agent and the other agents on the device. The method may further include providing on the virtual assistant platform an agent store from which the user may obtain at least one additional agent. The method may further include registering each of the additional agents for use on the user's device.

In accordance with another embodiment of the invention, a virtual assistant platform (VAP) operates on one or more computer servers and one or more devices. The VAP includes a plurality of virtual assistants, each of the virtual assistants having at least one agent, and one or more shared data stores accessible by each of the virtual assistants, the shared data stores providing the virtual assistants with shared capabilities. One or more of the shared data stores may include a world ontology understood by all of the virtual assistants. The world ontology may be included in an ontology hierarchy that further includes one or more domain ontologies within one or more of the data stores. The virtual assistant platform may further include a group virtual assistant to which one or more of the virtual assistants subscribes, the group virtual assistant being configured to distribute information to the subscribing virtual assistants according to a status of each of the virtual assistants. One of the virtual assistants may be an administrator virtual assistant configured to communicate with all of the other virtual assistants. The VAP may further include a virtual assistant bus configured to deliver only communications between the virtual assistants.

The VAP may further include a device client installed on each of the devices on which the VAP operates, and one or more of the virtual assistants may be configured to operate on one or more of the devices having one of the device clients. In each device, the virtual assistant operating on the device may include a main agent and a plurality of other agents, wherein the main agent communicates with the other agents and each of the other agents performs one or more tasks. At least one of the other agents on the device may be an adapter agent configured to communicate with an object. The VAP may further include an agent bus on each device, the agent bus configured to deliver only communications between the main agent and the other agents on the device. The VAP may further include a device bus configured to deliver only communications between main agents of the devices on which one of the virtual assistants is operating.

The VAP may further include an execution environment including a plurality of VAP-implementation services for configuring one or more of the VAs and one or more of the agents. The execution environment may include an application programming interface for agents to access the VAP-implementation services. The VAP may further include an agent store configured to implement one or more of the VAP-implementation services, and a device client installed on each of the devices may be configured to access the agent store.

In accordance with another embodiment of the invention, a method is provided for providing electronic assistance to a user. The method includes providing a VAP configured to share data across a plurality of virtual assistants, activating an agent in one of the virtual assistants, the agent located on a device client installed on a device of the user, and the agent being configured to perform one or more tasks, and providing on the VAP an agent store from which the user may obtain at least one additional agent. The VAP may include an execution environment including a plurality of VAP-implementation services for configuring one or more of the VAs and one or more of the agents, the agent store implementing one or more of the VAP-implementation services. The method may further include providing a device client to the user for installation on the device of the user, the device client being configured to access the agent store.

One of the VAs may be an administrator virtual assistant (AVA) comprising an agent store agent for communicating with the agent store, and the method may further include creating within the AVA a plurality of first agent templates accessible by the agent store agent. The first agent templates may include one or more device agent templates for creating a new agent for one or more specific devices. The first agent templates may further include a universal agent template for each of an associated agent in the agent store, each universal agent template containing all of the device templates for the associated agent. The first agent templates may include agent code, software installation modules, data, and/or metadata. One or more of the VAs may be an agent store VA, each agent store VA including an agent store agent for communicating with the agent store, and each agent store VA also including an agent template database storing a plurality of second agent templates accessible by the agent store agent of the agent store VA. The method may further include configuring the agent store to share the additional agents with at least one other VAP.

In accordance with another embodiment of the invention, a virtual assistant platform includes a plurality of virtual assistants, each of the virtual assistants being configured to communicate with a different user, and one or more agent stores configured to provide at least one agent to the virtual assistant of each user. The agent stores may be configured to register the agents for use on the virtual assistant platform, and may also be configured to maintain a catalog of the agents that have been registered for use on the virtual assistant platform. The VAP may further include an administrator virtual assistant (AVA) having both an agent store agent for communicating with one or more of the agent stores, and a plurality of first agent templates accessible by the agent store agent. The first agent templates may include one or more device agent templates for creating a new agent for one or more specific devices. The first agent templates may further include a universal agent template for each of an associated agent in the agent store, each universal agent template containing all of the device templates for the associated agent. The first agent templates may also include one or more of agent code, software installation modules, data, and metadata.

One or more of the VAs may be an agent store VA, each agent store VA having an agent store agent for communicating with the agent store, and each agent store VA having an agent template database storing a plurality of second agent templates accessible by the agent store agent of the agent store VA. One or more of the VAs may have an agent template cache configured to store a copy of one or more of the first agent templates.

### BRIEF DESCRIPTION OF THE DRAWINGS

The present invention will become more apparent from the detailed description set forth below when taken in conjunction with the drawings, in which like elements bear like reference numerals.

FIG. 1 is a schematic diagram of an example of a virtual assistant platform in accordance with the present disclosure;

FIG. 2 is a schematic diagram of the virtual assistant platform of FIG. 1 further showing a platform execution environment and a target platform;

FIGS. 3A and 3B are schematic diagrams of two examples of an intelligent agent;

FIG. 4 is a schematic diagram of an example of a composite intelligent agent;

FIG. 5 is a schematic diagram of a virtual assistant in accordance with the present disclosure;

FIG. 6 is a schematic diagram of another virtual assistant platform in accordance with the present disclosure.

FIG. 7 is a schematic diagram of an electronic device served by a plurality of agents.

FIG. 8 is a schematic diagram of a virtual assistant platform in communication with main agents of a plurality of electronic devices.

FIG. 9 is a schematic diagram of a communication flow between a plurality of personal virtual assistants in accordance with the present disclosure; and

FIG. 10 is a schematic diagram of a communication flow between a group virtual assistant and a plurality of personal virtual assistants in accordance with the present disclosure.

FIG. 11 is a schematic diagram of a system implementing a virtual assistant platform and an agent store in accordance with the present disclosure.

FIG. 12 is a schematic diagram of a virtual assistant platform with an agent store in accordance with a first embodiment of the system of FIG. 8.

FIG. 13 is a schematic diagram of a virtual assistant platform with a plurality of agent stores in accordance with a second embodiment of the system of FIG. 8.

FIG. 14 is a schematic diagram of a virtual assistant platform with a distributed agent store in accordance with a third embodiment of the system of FIG. 8.

### DETAILED DESCRIPTION OF THE INVENTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures. The figures depict selected embodiments and are not intended to limit the scope of embodiments of the invention. Skilled artisans will recognize the examples provided herein have many useful alternatives and fall within the scope of embodiments of the invention.

The following description refers to elements or features being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically, such as when elements or features are embodied in program code. Thus, although the figures depict example arrangements of processing elements, additional intervening elements, devices, features, components, or code may be present in an actual embodiment.

The invention may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, diodes, look-up tables, etc., which may carry out a variety of functions under the control of one or more microprocessors or other control devices. Other embodiments may employ program code, or code in combination with other circuit components.

In accordance with the practices of persons skilled in the art of computer programming, the present disclosure may be described herein with reference to symbolic representations of operations that may be performed by various computing components, modules, or devices. Such operations may be referred to as being computer-executed, computerized, software-implemented, or computer-implemented. It will be appreciated that operations that can be symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

As non-limiting examples unless specifically indicated, any database or data store described herein may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future. File systems for file or database storage may be any file system, including without limitation disk or shared disk, flash, tape, database, transactional, and network file systems, using UNIX, Linux, Mac OS X, Windows FAT or NTFS, FreeBSD, or any other operating system.

The various aspects of the invention will be described in connection with providing a virtual assistant platform for virtual assistants that communicate with users via electronic devices to perform particular tasks. That is because the features and advantages that arise due to the invention are well suited to this purpose. However, it should be appreciated that the invention is applicable to other procedures and to achieve other objectives as well.

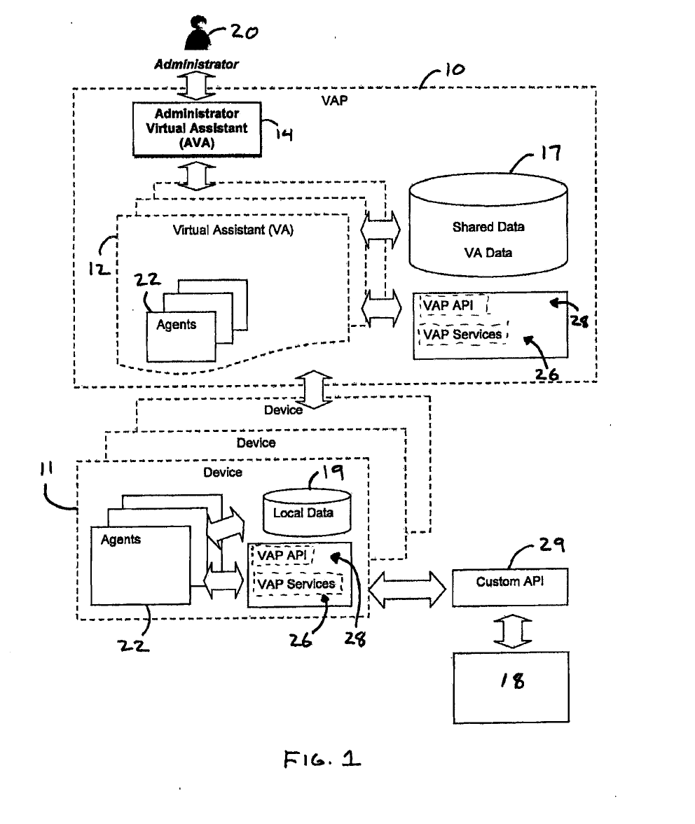

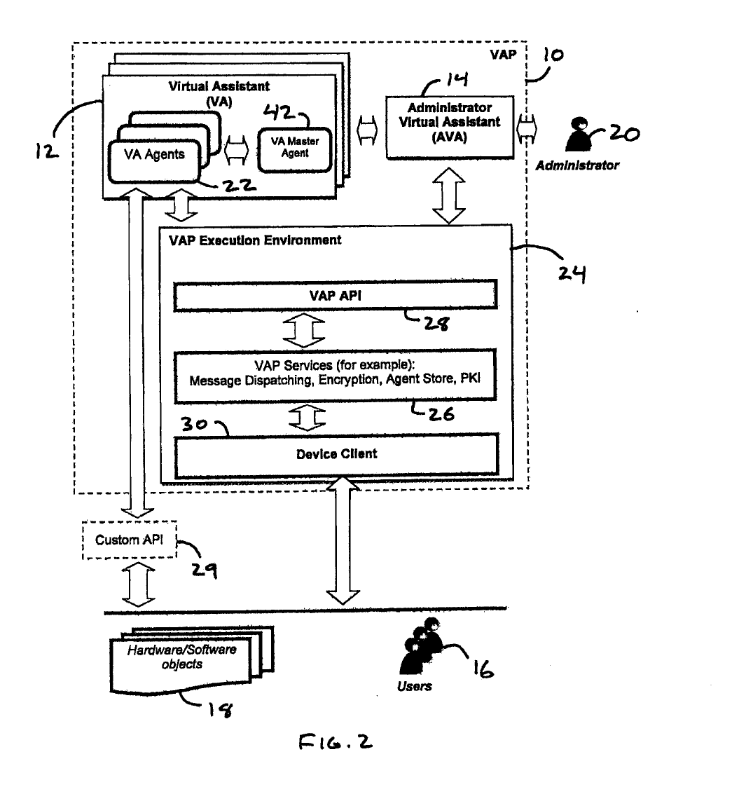

Referring to FIGS. 1 and 2, a virtual assistant platform (“VAP”) 10 may be a computing hardware or software framework, or a combination thereof, that provides the computational resources in at least one computer or computing device upon which one or more virtual assistants (“VAs”) 12 may operate. The VAs 12 may communicate with one or more users 16, and may further communicate with one or more hardware or software objects 18 through one or more devices 11 in electronic communication with the VAP 10, or on other computing devices as described in more detail below. The VAP 10 may be implemented in the cloud (on one or more virtual machines), on a remote server or across multiple servers, such that the VAs 12 communicate over the internet or another electronic network. Alternatively, the VAP 10 may be implemented on a user's 16 computer or computers, such that the VAs 12 communicate over a home network or other secured network. Alternatively, the VAP 10 may be implemented on a user's 16 mobile device or devices, such as a mobile phone or tablet, and the VAs 12 may communicate using the hardware and software interfaces of the mobile device, including communicating with the user 16 via sound or visual displays, and communicating with objects 18 on remote devices via the Internet or a cellular network.

The scope of communication between a VA 12 and users 16 or objects 18 may depend on the capabilities and accessible resources 17, 19 of the VA 12. In one embodiment, a VA 12 may be configured to deliver messages to a user 16 via an electronic device that the user 16 possesses, such as a desktop computer or a mobile phone. In other embodiments, a VA 12 may interact with a user 16 or a plurality of users 16, in that the VA 12 both delivers output to the user 16 and receives input from the user 16, which the VA 12 may transmit to a destination or perform other processing upon. In still other embodiments, a VA 12 may be configured to perform complex tasks, including personal tasks for a user 16 such as checking and sorting email or monitoring a home security system, or professional tasks such as normalizing data acquired in multiple formats or coordinating subordinate VAs, as described in more detail below. The VA 12 may store its resources, which may include accessible agents 22, local data 19, and shared or VA-specific data 17, locally or through access to a data store maintained by the VAP 10. A VAP 10 may include an administrative virtual assistant (“AVA”) 14 that is configured to manage the VAs 12 of the VAP 10. An administrator 20 may use the AVA 14 to add, delete, and configure VAs 12 according to the capabilities required of the VAP 10. Each VA 12 may perform tasks and communicate with the users 16, objects 18, other VAs 12, or other devices using one or more agents 22. An agent 22 may be an autonomous or semi-autonomous software or hardware component configured to perform a particular task, as described in more detail below.

Referring to FIG. 2, the VAP 10 may include an execution environment 24 configured to store and process agents 22, and further to provide VAP-implementation services 26 to the agents 22. VAP-implementation services 26 may enable the operation of agents 22, and therefore VAs 12, within the VAP 10 and between devices with which the VAs 12 communicate. Such services 26 may include, without limitation: an agent 22 registration service that creates, stores, searches, instantiates, manages, distributes, applies, and deletes agents 22 within a VA 12, and further tracks the agents 22 and VAs 12 with which an agent 22 may communicate; an agent 22 programming service for modifying the preprogrammed logic of the agent 22 as described below; an agent 22 interpreter that translates external requests into the agents' 22 language and vice versa; addressing and messaging services that identify appropriate agents 22 to receive messages, define how agents 22 identify and communicate with each other, and handle prioritization and delivery of messages; one or more security services for authenticating agents 22 and encrypting and decrypting their communications using certificate authorization, a public-key infrastructure, or any other means to secure the communication; one or more data storage and retrieval services, such as a shared data store service that shares common data between all VAs in a VAP; and one or more interfacing services.

The execution environment 24 may include a VAP application programming interface (“API”) 28 that allows multiple agents 22 to communicate with each other within a VA 12, between VAs 12, or to specific objects 18 or devices 11 as needed. Further, agents 22 may make use of the VAP API 28 to get access to VAP services 26 and related resources within the VAP 10. The VAP API 28 may provide a single standard programming interface for agents created in any programming language or operating system. The VAP API 28 may be implemented in any suitable software framework, such as MICROSOFT .NET, Web Services, ActiveX, SOAP, and the like. In one embodiment, all messages pertaining to VAP 10 functionality, including messages between agents 22 and messages pertaining to VAP resources 17, 19 and VAP services 26, may be passed through the VAP API 28, which may perform one or more of input validation, error handling, and interfacing with particular VAP services 26. Agents 22 may make use of one or more custom APIs 29 that function outside of the VAP execution environment 24 to perform external services as described in detail below.

Facilitating inter-agent and agent-to-service messaging through the VAP API 28 allows for standardization of message formatting and data access. The VAP API 28 may have or coordinate access to data or VAP 10 conditions that the agents 22 taking part in the message cannot access.

In some embodiments, message formatting and processing within the execution environment 24 may be implemented by a natural language processing pipeline. Natural language commands comprise phrases typically input by a user 16 and parsed according to sentence structure and parts of speech. The VAP API 28 or other elements of the execution environment 24 may be configured to execute the processing pipeline to determine the nature of the commands and distribute tasks and data to the appropriate agents 22. In addition to user 16 input, natural language syntax may be used for communications between agents 22 in place of or in addition to artificial programming protocols. Any suitable implementation of a processing pipeline may be used. By way of example, a message containing natural language may be: wrapped in XML or another tagging language to increase efficiency of processing; processed as a whole or divided into composite parts, such as text and object (i.e. a document attached to the message), subject and predicate, or parts of speech (i.e. verb, noun, prepositional phrase, and the like); parsed after receipt or in real-time as the natural language is entered; augmented with additional data at discrete processing steps; and analyzed to determine if multiple commands are present, such as when a user 16 enters a multiple-step script for one or more agents 22 to follow.

A device client 30 may be installed on each device that is to be connected to the VAP 10. The device client 30 may be a hardware or software component, as is suitable for the device on which it is installed. Suitable devices include any device that can be configured to transmit information about its state or receive input that modifies its state. Examples of such devices include, without limitation: personal computing devices such as desktops, laptops, tablet computers, mobile phones, digital media players, and the like; home or office audio or video equipment, such as televisions, projectors, theater components, recording or playback devices, and the like; dedicated servers, such as application, communication, mail, database, proxy, fax, file, media, web, peer-to-peer, standalone, software, or hardware servers, which may use any server format known in the art or developed in the future (possibly a shared hosting server, a virtual dedicated hosting server, a dedicated hosting server, or any combination thereof); monitoring systems, such as home security systems, thermostats, vehicle status monitors, infant monitors, and the like; wearable devices, such as watches, goggles, bracelets, devices implanted into cloth, and the like; and biological implants, such as pacemakers, catheters, and the like. Suitable devices may further include software-based or pure-software devices, including, without limitation: cloud computing frameworks, such as AMAZON ELASTIC COMPUTE CLOUD, MICROSOFT WINDOWS AZURE, and the like; search engines; social networks; and email services. The device client 30 may be configured to communicate with one or more agents 22 of one or more VAs 12. The device client 30 itself may comprise one or more agents 22, either permanently or upon receiving an agent 22 from the VAP 10, that perform particular tasks upon the device or objects 18 contained therein, or interact with a user 16 thereof. In one embodiment, the user 16 installs a device client 30 on each device that the user 16 wants to communicate with the VAP 10. The installation itself of the device client 30 may authorize the device in the VAP 10, or the user 16 may separately authorize the device for use in the VAP 10. Once installed, the device client 30 may coordinate local device resources for access by the VA 12. Such coordination may include providing, to one or more agents 22, access to all or a subset of the user's documents, photographs, device settings, applications, usage authorizations, and other information stored on the local device, as well as control of all or a subset of the device's equipment, such as video camera, speakers, sensors, and the like. Such access may depend on permissions set by the user.

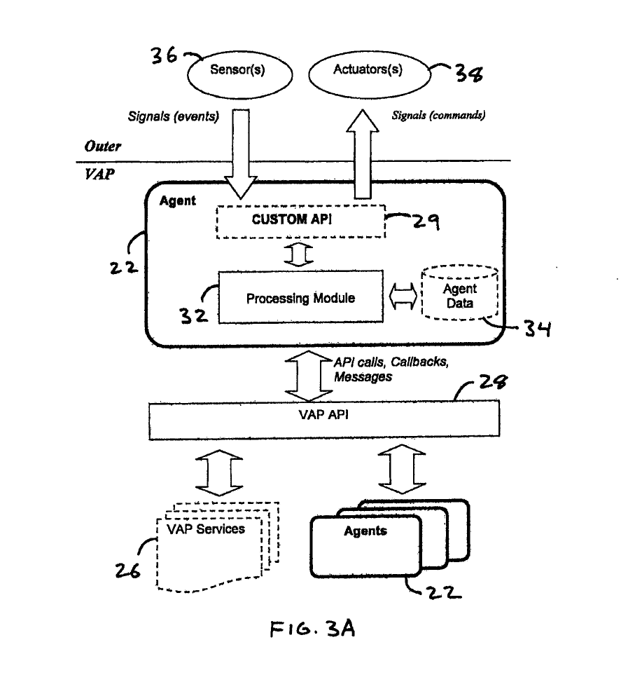

Referring to FIGS. 3A and 3B, an agent 22 may be configured to observe or interact with the outside world, which comprises one or more environments outside the VAP 10. Outside worlds can include physical environments, software or other computing environments, other VAPs, and other environments. As shown in FIG. 3A, the agent 22 may receive, as input, a signal from one or more sensors 36, and may transmit, as output, a signal to one or more actuators 38. A sensor 36 is a device or software program that may indicate the occurrence of an event or transmit status information to the agent 22 upon request, at predetermined intervals, or when the event occurs. Examples of sensors may include but are not limited to temperature sensors, gyroscopes, accelerometers, optical sensors, biometric sensors, and the like. An actuator 38 is a device or software program that performs an action accord to a command sent by the agent 22. As shown in FIG. 3B, the agent 22 may exchange input and output with a hub 31 that manages communications to and from a plurality of networked devices 33. The device 33 may be user devices as described above, or may be “smart” devices that control or monitor objects 18 or perform other external services. For example, the hub 31 may be a device controller for a user's 16 home, and the devices 33 may be networked control units for controlling an alarm system, HVAC system, central power or power outlet, water heater, lighting system, and the like. The agent 22 may further exchange input and output with other agents 22. The agent 22 uses the VAP-implementation services 26 described above as needed.

An agent 22 may perform tasks that require communication with objects 18 or that relate to external services—that is, services that are not connected to the VAP 10. External service functionality can be made available to agents 22 of a VA 12 through third-party provision of a custom API 29 that includes program routines and instructions to configure the agent 22 for performing the tasks. For example, the custom API 29 may include a program routine that turns on exterior lights at a users 16 home. An agent 22 tasked with receiving an input, determining if the input indicates the exterior lights should be turned on, and turning on the exterior lights may access the custom API 29 to execute the associated stored program routine. Similarly, an agent 22 may be configured to serve as an adapter for driving communication between the VAP 10 and an external device, such as the hub 31, networked device 33, or another device 11 connected to the user 16 or object 18. Such an adapter agent may be provided to the VAP 10 from a third party. The adapter agent may be distributed to the VAP 10 and made available to other VAPs through an agent store 80 as described below. The adapter agent may inform the VAP 10 of the basic actions the external device can perform and the commands the external device is capable of interpreting. The VAP 10 may then use other agents 22 to translate more complex commands, such as natural language phrases as described above, into the basic commands provided by the adapter agent.

The agent 22 may comprise a processing module 32 and an agent data store 34 that may be accessed and modified by the processing module 32. The processing module 32 may comprise preprogrammed logic that defines the behavior of the agent 22. The preprogramming logic may include one or more algorithms, implemented with hardware or software modules, for processing input, deciding what action to take, if any, based on the input, and generating output according to the selected action. The behavior of the agent 22 may have a particular degree of complexity. In some embodiments, the agent 22 may be an intelligent agent capable of choosing and taking action in pursuit of accomplishing one or more tasks or subtasks. The agent 22 may further be capable of learning, in that the logic and its algorithms may change over time in light of input, output, and/or data in the agent data store 34.

The agent data store 34 may comprise one or more agent knowledge stores and one or more agent file stores. An agent knowledge store may include one or more ontologies. An ontology may be understood herein to mean a collection of data that defines the scope and procedures by which agents 22 may perform tasks. An ontology may contain facts, rules, and other types of structured and unstructured information typically found in a knowledge base. Data in an ontology may be unstructured or may be organized into files, databases, hierarchies, and the like. An ontology may facilitate the agent's 22 communication with other agents 22 within or outside the VA 12, and further may facilitate the agent's 22 communication with users 16, objects 18, or other devices outside the VA 12. Ontologies may be shared with other data stores and repositories in the VAP 10, such as in the shared data store 17, VA shared data store 52, or device data store 54, in order to facilitate this communication.

The agent 22 may update each ontology through receipt of input or other processing, or the VA 12 may update each ontology, such as when a software, firmware, or hardware upgrade is propagated in the VAP 10. The rules of each ontology may be organized into one or more rule sets that are interpreted by the processing module 32 in order for the agent 22 to perform tasks. Rules may be added, removed, or changed within each rule set as needed for the agent 22 to perform its tasks or subtasks. An agent file store may include one or more files, such as image or document files, databases, folders, and other articles of data that the agent 22 may access in performance of its tasks. The agent file store may be accessible only by the agent 22, or may be a shared file store accessible by other agents or VAs.

According to the algorithms, rules, and data provided to it, the agent 22 may perform one or more tasks or subtasks, and may be dedicated to such tasks or subtasks or may be capable of learning new tasks or subtasks to perform. As non-limiting examples, an agent 22 may perform: speech recognition; text-to-speech conversion; text, graphical, or video displays; event scheduling and notification; alarm monitoring and notification; web crawling and searching; digital information aggregation and distribution; personal transacting such as stock transfers, store purchases, or reservation booking; phone or video call management; document and other file normalization, including conversion between different formats and display and editing functionality; context interpretation, wherein the agent 22 parses environmental conditions such as time, temperature, and location, and informs other agents 22 if the context affects their operation; updating and retrieving information from the user's accounts at various web sites, web services and social networks; and the like. The agent 22 may be configured to adapt to a user's 16 routines, preferences, habits, behaviors, and moods. For example, such information about the user's 16 routines may be, at least partially, determined using feedback from the sensor alone or in combination with user input. For example, the user's 16 mood may discerned by feedback from optical and temperature sensors 36 in combination with feedback discerned from information communicated through the device, such as a user updating a social network status to indicate information about the user's mood.

The agent 22 may be configured to expand its knowledge and file stores with respect to particular tasks or topics. For example, a VA 12 that assists a doctor can include an agent 22 that aggregates formal ethical opinions, an agent 22 that consolidates collected opinions to produce and update a list of consultation requirements, an agent 22 that records patient consultations, an agent 22 that parses transcripts of the consultations to check that the consultation requirements are met, and an agent 22 that presents and updates a checklist indicating whether the doctor has fulfilled the consultation requirements in real time during the consultation.

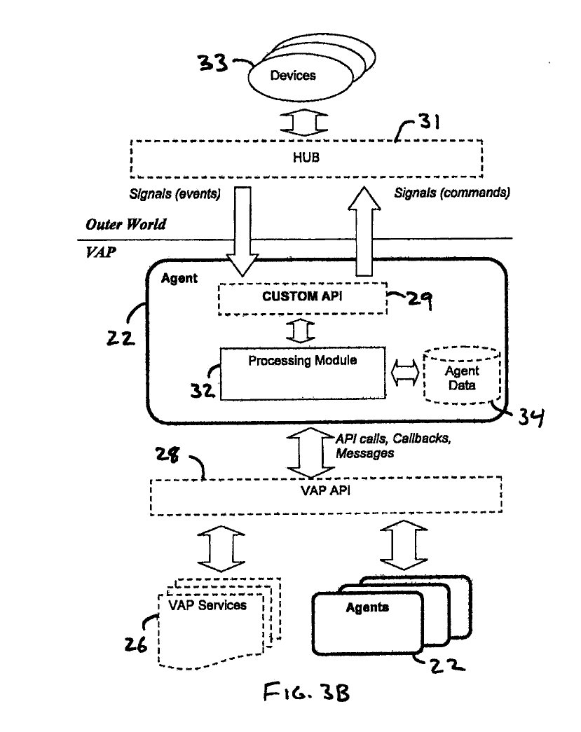

Referring to FIG. 4, one or more agents may be a composite agent 40 comprising a master agent 42 and one or more dependent agents 44. The master agent 42 and each dependent agent 44 may have a configuration as described with respect to FIG. 3, above. However, the dependent agents 44 may be restricted from communicating with the outside world, and may be dedicated to performing tasks within the composite agent 40. The master agent 42 may coordinate the activities of the dependent agents 44 and may communicate outside the composite agent 40. In addition or alternatively to its own agent data store 34, the master agent 42 and each of the dependent agents 44 may access a shared data store 46 that may include knowledge and file stores as in the agent data store 34. The structure of the composite agent 40 advantageously allows delegation of subtasks by the master agent 42 to dependent agents 44.

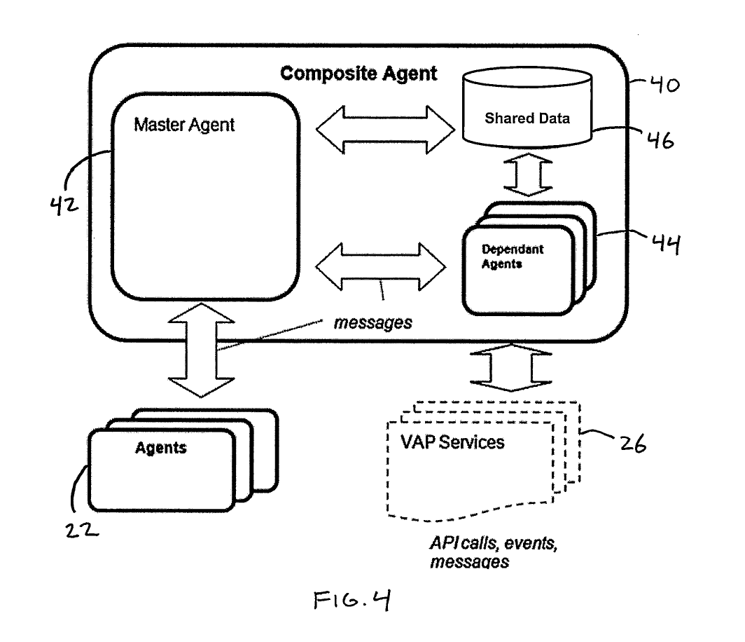

Referring to FIG. 5, a composite agent may be distributed within a VA 12 such that the master agent 42 resides outside of the devices 50 to which the VA 12 is connected, while dependent agents 44 reside on each of the devices 50. In one embodiment, the master agent 42 resides in a distributed system, such as a cloud computing framework. The master agent 42 may access a VA shared data store 52, which may be dedicated to the master agent 42 or shared with additional master agents, if the VA includes a plurality of composite agents, or with agents 22 that are not composite.

The VA shared data store 52 may include one or more ontologies, as described above with respect to the agent data store 34, that facilitate the VA's 12 internal communication between agents in the VA 12, and external communication with devices 50, users 16, objects 18, and agents 22 of other VAs 12. Ontologies within the VA shared data store 52 may include a “world ontology” comprising vocabulary and taxonomy that is common to all VAs 12 in the VAP 10. Ontologies within the VA shared data store 52 may also include one or more private or semi-private (i.e., shared) ontologies that may be understood only by the VA 12 and the devices 50 that are connected to it. The ontologies may be organized into one or more hierarchies according to the system components that can access and/or understand each ontology. In an embodiment of an ontological hierarchy, the world ontology may be the broadest ontology, as it may be understood by all agents 22, 40 and VAs 12 in the VAP 10. At the opposite end of the hierarchy, a domain ontology may govern access to a particular element or set of elements in the system (i.e., a domain) by defining the logic and data for the domain. A domain may be a file, a database or set of databases, an agent or set of agents, an object or set of objects, a VA (e.g., any VA described herein), etc. An upper ontology may be an ontology that defines logic and data for a set of domains. Definitions from higher ontologies may pass by inheritance to ontologies below within the hierarchy.

The VA 12 may update each ontology directly or through output from agents. The ontologies in the VA shared data store 52 may further include one or more rule sets that are interpreted by the processing module 32 of each agent 22 or master agent 42, and that may be propagated by the master agent 42 to its dependent agents 44. Rules may be added, removed, or changed within each rule set as needed for the agents of the VA 12 to perform their tasks or subtasks. Thus, the VAs 12 and their agents that access the ontologies may expand the sets of facts and definitions and the logic and framework thereof to accommodate an expanding field of information.

The VAP 10 may use the world ontology to grant shared capabilities to the VAs 12 of the VAP 10. Shared capabilities are tasks, such as reporting, file management, interaction, user representation, secured transaction, information retrieval, and information sharing, that a VA 12 may partially or fully perform for a user 16. The tasks are shared, or sharable, between VAs 12 because the VAs 12 have access to the same secured data stores and specially-programmed agents 22, 40 that allow performance of the tasks. In this manner, a VAP 10 may comprise a distributed system that provides the same type of assistance to all of its users 16 through their corresponding VAs 12. Furthermore, each user 16 may be able to assist or otherwise communicate with the other users 16 of the VAP 10 in one or more ways, including, without limitation: providing computing resources by connecting devices 50 to the VAP 10; answering questions or otherwise providing information through the VA 12, which may be added to the world ontology or another shared knowledge store; connecting the user's 16 VA 12 to one or more social networks; and sharing data over a secured channel.

Agents 22 or dependent agents 44 of the VA 12 may engage a device 50 by communicating with the device client 30, and therefore the agents may not be instantiated on the device 50 itself. In this embodiment, the agents 22 or dependent agents 44 may be instantiated remotely from the device 50, such as within a cloud computing framework or on a remote server. Alternatively or additionally, one or more agents may be instantiated on the device 50 itself, so that a network connection to the agents' location is not required. Within each device 50, the agents may access a device data store 54 comprising the device data, the type of which may depend on the device 50 but may include files, databases, and system settings on which the agents may operate.

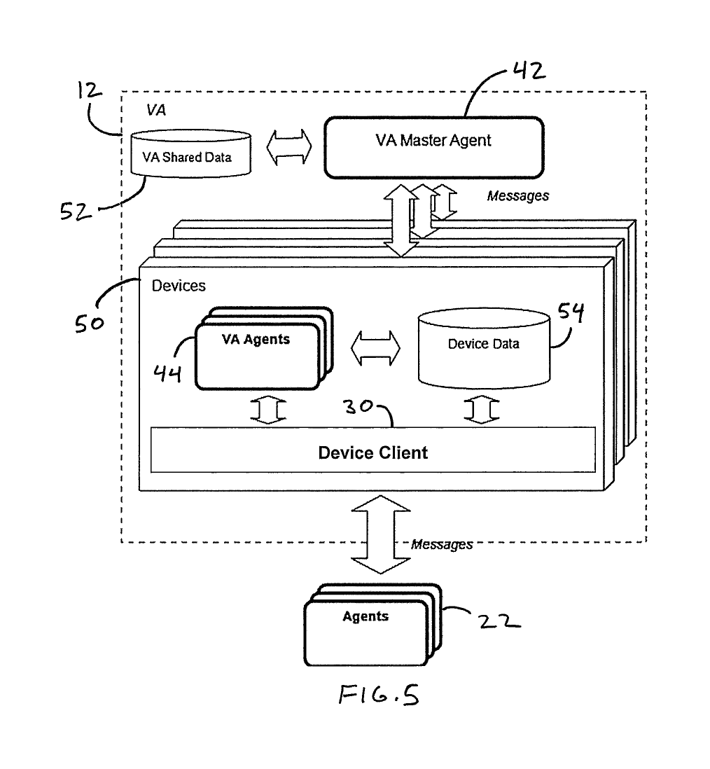

Referring to FIG. 6, another embodiment of the VAP 10 may use one or more main agents 72 in place of the master agent 42. A main agent 72 may have similar composition and function to a master agent 42, in that a main agent 72 resides on each VA 12 and interfaces with other agents 22 to manage the activities of the latter. The main agent 72 may be a composite agent but is not required to be. The main agent 72 may belong to a class of agents referred to herein as service agents. Service agents may be distributed to devices 11 together with the device client 30 and cannot be changed by the user. Service agents may perform basic VAP services, like those performed by VAP services 26, and may communicate with each other over dedicated communication channels, or busses. Service agents may be granted full permissions to access VAP 10, device 11, and VA 12 resources and information in order to perform their tasks.

A main agent 72 may be configured to enable its VA 12 on its device 11 regardless of the accessibility state of any other elements of the VAP 10. Thus, preferably, all VAs, including the AVA 14, have a main agent 72. In FIG. 6, the AVA's 14 main agent 72 may access the shared data 17, and may communicate with main agents 72 on each device 11 in the VAP 10 via a VA bus 74. Preferably, only main agents 72 can communicate over the VA bus 74. Device-centric operation of the main agent 72 is described below.

In some embodiments, a device 11 (e.g., Device 1 . . . N in FIG. 6) may host multiple VAs 12 from a single VAP 10 (e.g., VA 1 . . . N in FIG. 6) or multiple VAs from multiple VAPs. In one example, the device 11 is a virtual machine hosted in a cloud service and configured to server multiple VAs 12. For such coexisting VAs 12, access to the device 11 resources may be shared, and in some cases may be maximized (i.e., 100% of device resources used) through dynamic allocation of the resources to each concurrently operating VA 12.

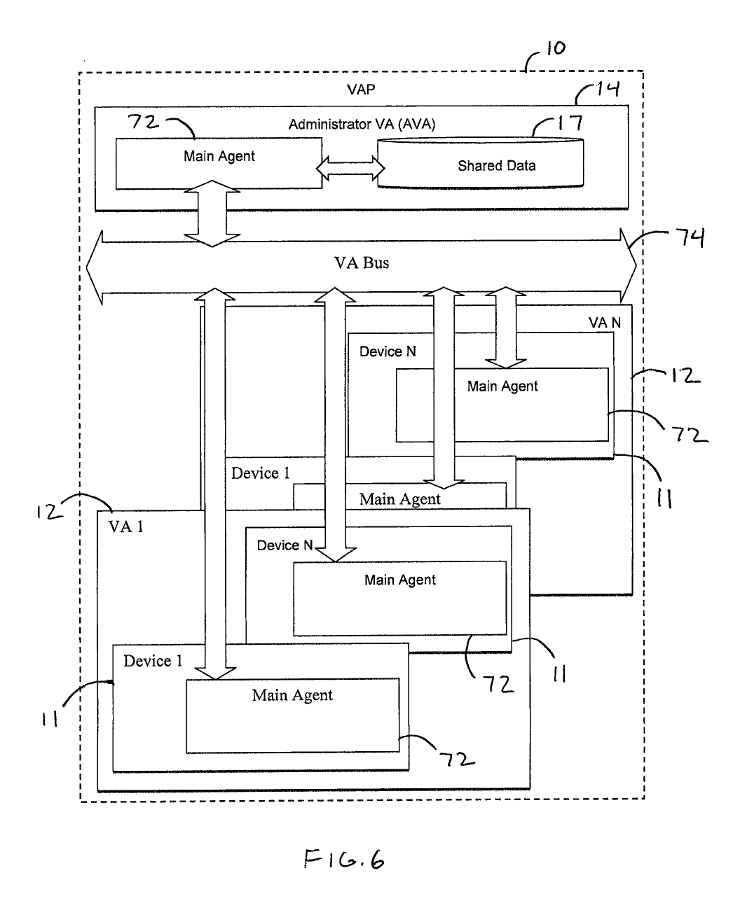

Referring to FIG. 7, in another embodiment of the VAP 10 the device client (not shown in FIG. 7) may include program code, modules, instructions, and/or data for implementing the VA 12 agents and services on a particular device 11. This implementation may include the main agent 72 communicating with other agents on the device via an agent bus 76. The agent bus 76 is a communication channel that may be dedicated to agent-to-agent communications on the device 11. The main agent 72 may also access data such as that stored in the VA shared data store 52 and device data store 54. Via the main agent 72 and agent bus 76, other agents on the device may also access the data on the device 11 to which the main agent 72 has access, provided such agents are granted the appropriate permissions to do so.

FIG. 7 further illustrates agents that are specialized for operation on the device 11. A store agent 75 may be any agent 22 as described above, which is downloaded to the device 11 from an agent store as described below. The store agent 75 may be configured to perform particular tasks and may have been designed by third parties unfamiliar to the device 11 operator. For security reasons, store agents 75 may be granted restricted access to device 11 resources and communication channels. In some embodiments, the store agents 75 may be placed in a “sandbox” 73, which is a software wrapper restricting agent 22 capabilities in accessing and modifying VA 12 data and logic.

Service agents 77 are described above with respect to the main agent 72. They may be part of the integral layer of VAP 10 operation and may have full access to all device 11, VA 12, and VAP 10 resources. Adapter agents 78 may provide communication between the VA 12 and the outside world. As described above, adapter agents 78 may receive data in the form of events from external objects 18, such as other software services (e.g., Dropbox, Facebook) or other devices (e.g., video camera, keyboard, mouse, water sprinkler system). The adapter agent 78 receiving the event creates an agent message from the event and passes it to the appropriate agent 22 via the agent bus 76. Similarly, the adapter agent 78 may receive an agent message from another agent 22 in the form of a command to be translated and sent by the adapter agent 78 to one or more of the objects 18. Adapter agents 78, like store agents 75, may be created by an unfamiliar third party and downloaded to the device 11 from the agent store. Thus, adapter agents 78 may be placed in a sandbox 73 for security reasons.

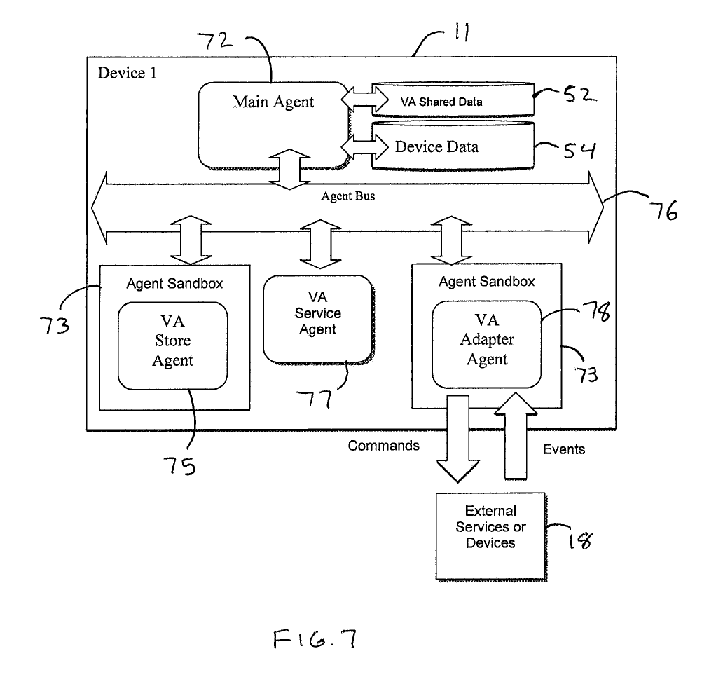

Referring to FIG. 8, a plurality of devices 11 (i.e., Devices 1 . . . N) may each subscribe to a VA 12 that facilitates communication with each of the main agents 72 via a device bus 71. That is, each device 11 that subscribes to the VA 12 may have a main agent 72 that is dedicated to implementing the VA 12 on the device 11, and this main agent 72 communicates with the VA 12 via the device bus 71. The device bus 71 is a communication channel that may be dedicated to communications between main agents 72. The device bus 71 may also support communications between main agents 72 and the AVA 14 of the VAP 10 via the VA bus 74. Each main agent 72 may then deliver agent messages to the one or more agents 22 of the VA 12 on the device 11 (i.e., VA Agents 1 . . . N).

The VA shared data store 52 may be completely or partially replicated across all devices 11 that subscribe to the VA 12. Through this redundancy of shared data, processing may be partially or fully decentralized as agents 22 on any server or device 11 may operate autonomously upon the shared data it requires to do so. In some embodiments, each device 11 may have a VA shared data store 52 physically present on the device 11. In one embodiment, the VA shared data store 52 may contain only the shared data that is needed for operation of the VA 12 on the device 11. In other embodiments, each device 11 may contain a reference to a centrally stored VA shared data store 52. Each device 11 may also have one or more device data stores 54 as described above.

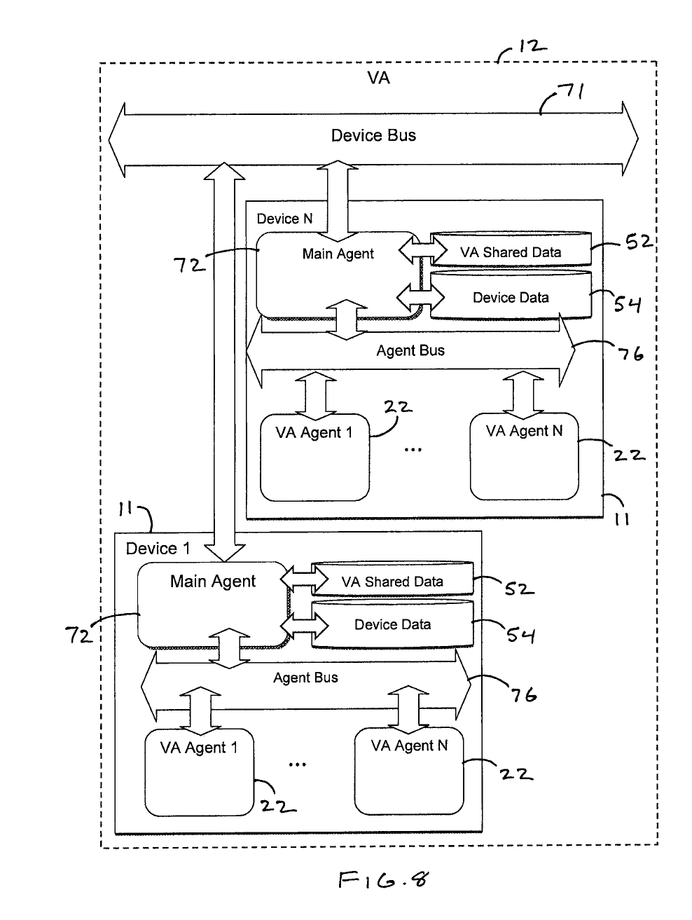

Referring to FIG. 9, the VA 12 may be configured to communicate with a second VA 62, which may be on the same VAP 10 as the first VA 12 or may be on a second VAP 60, unless communication between the VAPs 10, 60 or between the VAs 12, 62 is prohibited by one or both administrators 20, 64. For example, where the VA 12 and second VA 62 are on the same VAP 10, the VAP 10 may serve as a certificate authority or other security key provider to both VAs 12, 62. In another example, a user 16 of the first VA 12 may share a document with a user 66 of the second VA 62 by instructing its VA 12 to send the document to the second VA 62. This document transfer can require authentication of the second VA 62, such as by requiring the second VA 62 to visit a particular web address and provide a digital certificate or other security key.

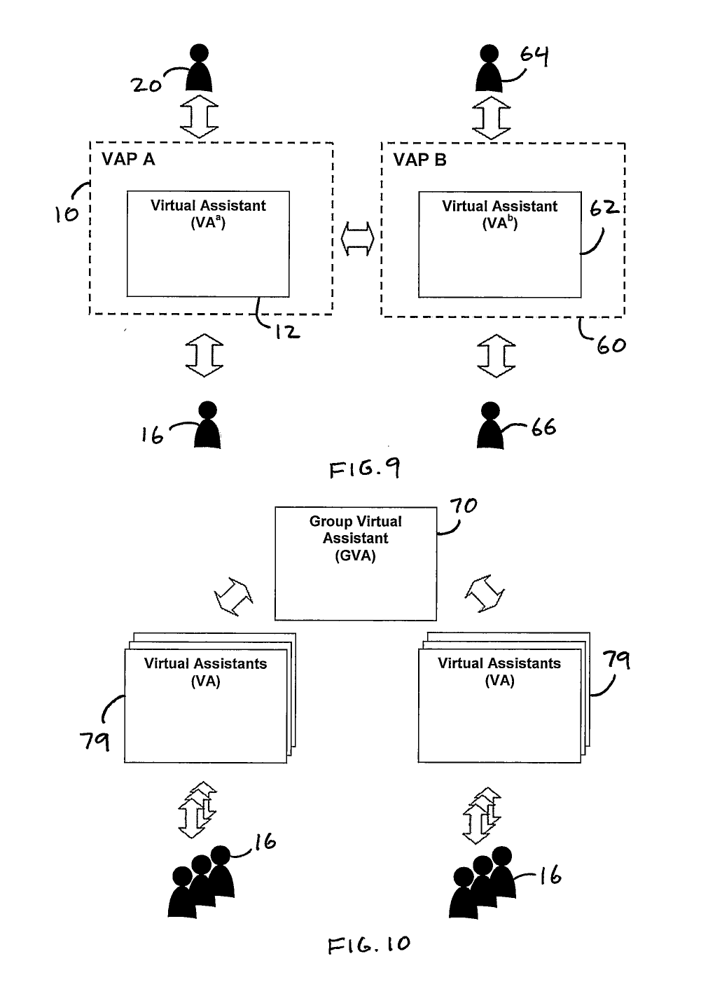

Referring to FIG. 10, a group VA 70 may facilitate data exchange between a plurality of subscriber VAs 79. A group VA 70 may be advantageous in a VAP 10 implemented or used by an organization, such as a company, or by an individual in a head-of-household role where family members and devices in the home may use subscriber VAs 79. The group VA 70 may be configured to optimally distribute information between the subscriber VAs 79 by maintaining, such as in its VA shared data store 52, data describing the state of each subscriber VA 79 and its users 16. For example, a group VA 70 for an elementary school may track that a parent using a subscriber VA 79 has a child in Teacher A's second grade class and a child in Teacher B's fourth grade class. The group VA 70 may thereby send only relevant information to that parent's subscriber VA 79, such as general school information, information about second and fourth grade events, and information about Teacher A's and Teacher B's classes.

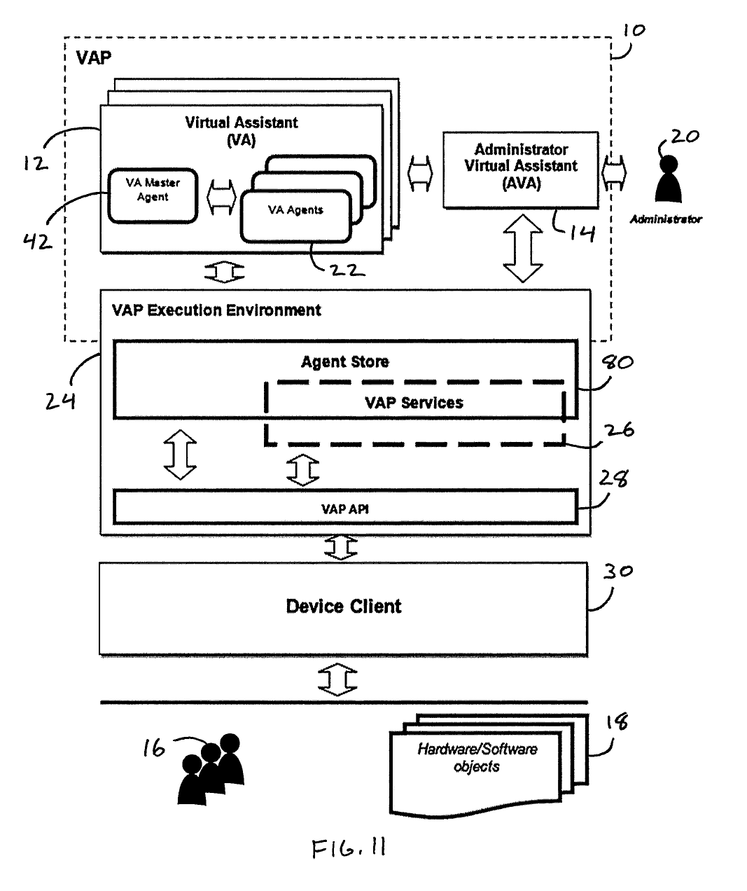

Referring to FIG. 11, the execution environment 24 of the VAP 10 may include an agent store 80, which may be a software component for managing the agents 22 and composite agents 40 that the device client 30 may utilize. The agent store 80 may implement one or more of the VAP-implementation services 26, including, without limitation: registering new agents 22 within the VAP 10 to make them available for retrieval and use by device clients 30 and other VAP 10 users 16; before or in conjunction with registering an agent 22, digitally certifying the authenticity of the agent 22, such as by signing the agent 22 as a Certification Authority; hosting agents 22, including locally or remotely storing code and data pertinent to an agent 22; authorizing distribution of an agent 22 to a user, and transmitting the agent 22 to the user 16; packaging a plurality of agents 22 into an agent package, which can be digitally certified and distributed like an agent; maintaining a catalog or database describing all available agents 22; facilitating financial processing of agent-related transactions, including purchasing of agents 22 and handling transactions initiated by agents 22; certifying and distributing data associated with an agent 22 or with a type, group, package, or classification of agents 22.

The agent store 80 may interface with a user 16, directly or through a device client 30, to allow the user 16 to expand its use of the VAP 10 by adding VAs 12 or agents 22. A user 16 may access the agent store 80 to acquire a new VA 12 or agent 22, which may be available for free or fee-based acquisition. The agent store 80 may provide an agent catalog for the user 16 to search. In this manner, the user 16 may personalize his own experience with the VAP 10 by setting up one or more VAs 12 with agents 22 specific to his needs. For example, an interior designer may acquire a VA 12 configured to access one or more private or public design-relevant information sources, such as the website of INTERIOR DESIGN MAGAZINE, YELP pages and TWITTER accounts of local interior designers, or the interior designer's PINTEREST account, and display new posts to the designer's device. The interior design-specific VA 12 may further be configured to exchange information with a group VA 70 that connects the interior designer's VA 12 with VAs of other users 16 interested in interior design. The VAs 12 or agents 22 available through the agent store 80 may be updated individually, collectively in subsets, or collectively as a whole, depending upon the type of update. For example: a single agent 22 may be updated with a new rule set; a group of agents 22 making up a VA 12 may be updated collectively to add new functionality to the VA 12; or, all of the agents 22 in the agent store 80 may be updated collectively to reflect changes to the VAP 10.

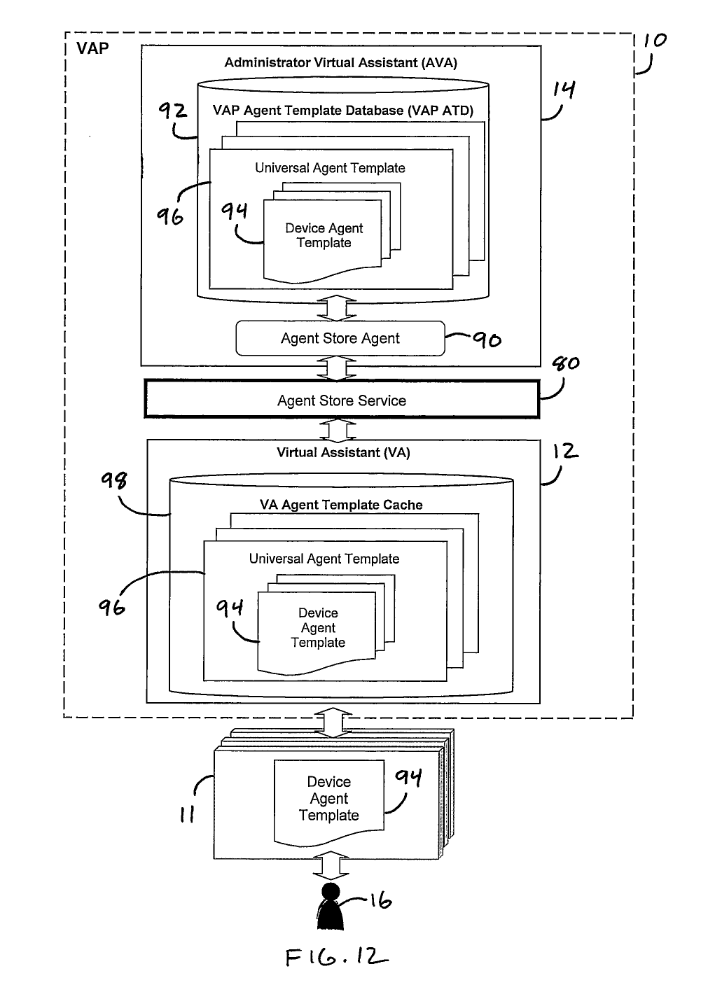

Referring to FIG. 12, the AVA 14 of a VAP 10 may coordinate the distribution of agents 22 through the agent store 80 to one or more VAs 12 using an agent store agent 90. The agent store agent 90 may be an agent 22 as described above, specially configured to access a VAP agent template database (“ATD”) 92 stored by the AVA 14. The VAP ATD 92 may be a database or other data store that contains agent templates for the agents 22 available to all VAs 12 on the VAP 10 through the agent store 80. An agent template is an installation package containing all data, software, and firmware modules that the associated agent 22 requires to operate on one or more devices. The agent template may include, without limitation: agent code, such as precompiled source code modules for execution on a physical or virtual machine, or software modules such as device drivers for executing the agent in specific operating systems or other execution environments; software installation modules; data, such as databases, files, operating rule sets, permissions, and the like; and metadata, such as knowledge about other agent templates, knowledge about hardware or software requirements of the target device, or versioning and security information, such as digital certificates authenticating the agent template and its components. Agent templates in the VAP ATD 92 may include device agent templates 94, which are agent templates designed for a specific type of device (i.e. Windows desktop computer, iOS device), and universal agent templates 96, which are packages containing all of the agent device templates 94 for a particular agent 22.

In order to take advantage of the agent templates, each VA 12 may maintain an agent template cache 98. The agent template cache 98 contains one or more agent templates for each agent 22 that has been added to the VA 12 as described above. In some embodiments, as illustrated, the agent template cache 98 may contain the universal agent template 96 and its corresponding device agent templates 94. The VA 12 may then distribute the proper device agent template 94 for a particular device 11 to the device 11 as described further below. The agent template cache 98 may be a database or data store that stores an exact copy of each agent template that the VA 12 receives from the AVA 14. Alternatively, the agent template cache 98 may be a list of references, such as location pointers, to the relevant agent templates that are stored in the VAP ATD 92 or another ATD as described below.

Use of the agent 22 within a VA 12 may include discovery, delivery, and updating of the agent 22. The availability of the agent 22 is discovered through an external event, such as an action by the user 16, an object 18, or another agent 22. The VA 12 may identify that the agent 22 is available by communicating with the agent store 80 and receiving confirmation that at least one agent template for the agent 22 is in the VAP ATD 92. The VA 12 then requests the agent store 80 to download the corresponding agent template, particularly the universal agent template 96 if one exists. The agent store 80 instructs the agent store agent 90 to retrieve the requested universal agent template 96, by which the agent store agent 90 may make and return a copy of the universal agent template 96 or may return a reference to the universal agent template 96 in the VAP ATD 92. The VA 12 receives the universal agent template 96 from the agent store 80 and stores the universal agent template 96 in the agent template cache 98. The VA 12 may proceed to install the universal agent template 96 on the target device 11, or may wait for a device installation event, such as power-on or power-off of the device 11, connection of the device 11, or expiration of a time, to occur.

When it is time to install the universal agent template 96, the VA 12 selects the proper device agent template 94 for the device 11 and transfers the device agent template 94 to the device 11. The device client 30 on the device 11 may receive the device agent template 94, and may concurrently or subsequently receive a command to install the agent 22. The device client 30 then installs the agent 22 according to the instructions and data in the device agent template 94 and notifies the VA 12 when the installation is complete. Subsequent updating of the agent 22 may be required when a new version of the agent template becomes available. The AVA 14, through the agent store agent 90, may notify any VA 12 that had previously downloaded the agent 22 that a new version of the agent 22 is available. The VA 12 may then initiate a download and installation of the new version as described above.

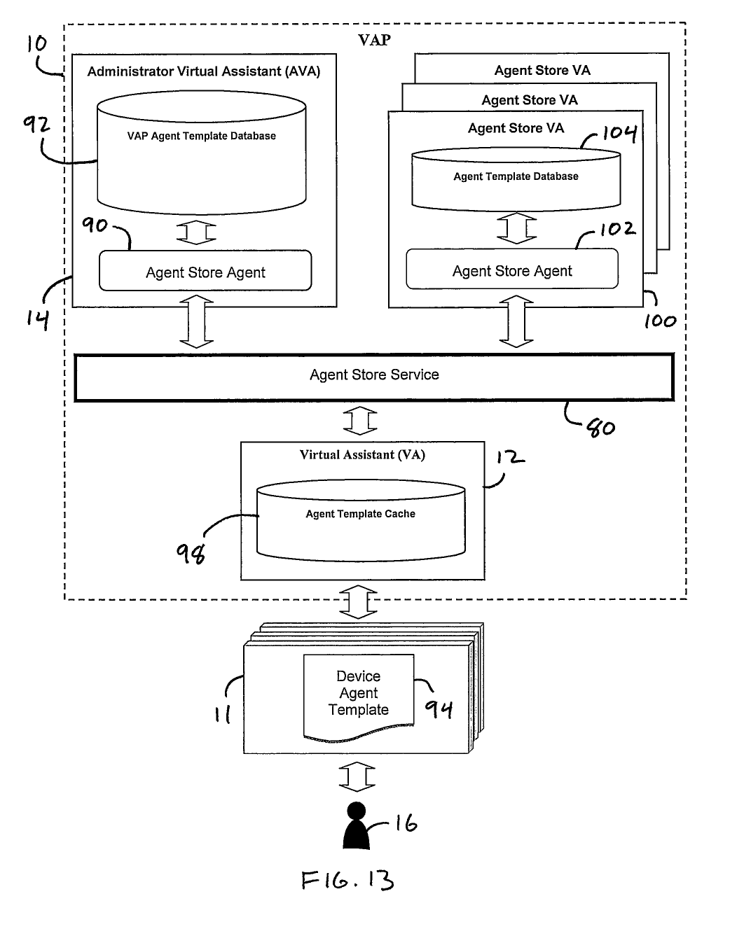

Referring to FIG. 13, the VAP 10 may include one or more agent store VAs 100 that are individually configured to provide their own agents 22 to other VAs on the VAP 10 through the agent store 80. Each agent store VA 100 may include its own agent store agent 102 and ATD 104 that function analogously to the agent store agent 90 and VAP ATD 92 maintained by the AVA 14. That is, the ATD 104 stores agent templates for the agents 22 on the agent store VA 100, and the agent store agent 102 retrieves and distributes the agent templates in response to requests from the agent store 80. The agent templates of the ATDs 104 are stored, discovered, delivered, installed, and updated on VAs 12 and devices 11 as described above.

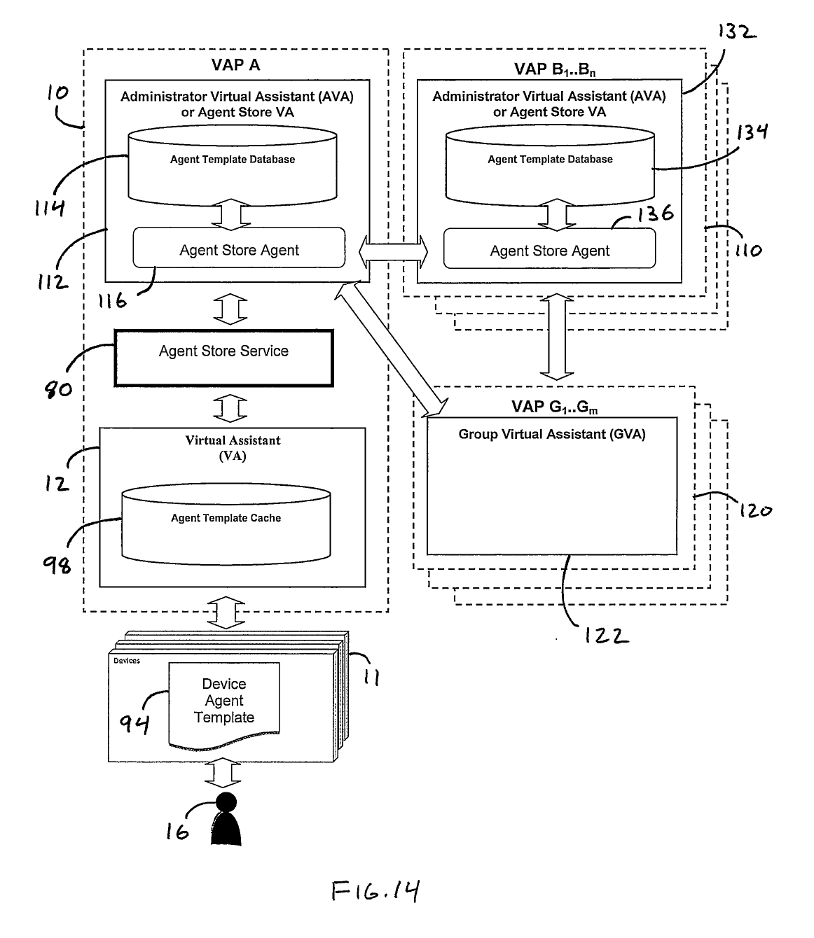

Referring to FIG. 14, the agent store 80 may provide access to agents 22 that are distributed across a plurality of VAPs 10, 110, 120. Distribution of agents 22 from a store-enabled VA 112, such as the AVA 14 or agent store VA 100, to VAs 12 within the same VAP 10 may proceed as described above. Further, the store-enabled VA 112 of a first VAP 10 may serve as a proxy to provide VAs 12 of its VAP 10 with access to agent templates stored in the ATD 134 of a store-enabled VA 132 on a second VAP 110. The agent templates in the ATD 134 on the second VAP 110 may be accessed directly by VAs 12 through communication between the agent store agents 116, 136 of the store-enabled VAs 112, 132 on each VAP 10, 110. For example, the agent store agents 116, 136 may negotiate a secure connection and then provide agent discovery and delivery services, as described above, upon receiving a request for an agent 22 from a VA 12.

In some embodiments, the agent templates in the ATD 134 on the second VAP 110 may be accessed indirectly by VAs 12 through connection of the first VAP 10 and second VAP 110 to one or more group VAPs 120. The store-enabled VA 112 of the first VAP 10 may subscribe to a group VA 122 in the group VAP 120. The store-enabled VA 132 of the second VAP 110 may subscribe to the same group VA 122, and may therethrough be registered with the group VAP 120 as a store-enabled VA. Such registration makes the agent templates in the ATD 134 available to all subscribing VAs of the group VA 122. The agent 22 availability may appear seamless to the user 16. That is, the user 16 gains access to all agents 22 through the VA's 12 communication with the agent store 80 on its own VAP 10, regardless of which VAP is providing the available agents 22.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Finally, it is expressly contemplated that any of the processes or steps described herein may be combined, eliminated, or reordered. Accordingly, this description is meant to be taken only by way of example, and not to otherwise limit the scope of this invention.

What is claimed is:

1. A method for providing electronic assistance to a user, the method comprising:
providing a virtual assistant platform (VAP) configured to share data across a plurality of virtual assistants (VAs);
activating an agent in one of the VAs, the agent located on a device of the user, and the agent being configured to perform at least one task; and
providing on the VAP one or more agent stores from which the user may obtain at least one additional agent.

2. The method of claim 1, wherein the VAP includes an execution environment including a plurality of VAP-implementation services for configuring one or more of the VAs and one or more of the agents, the agent store implementing one or more of the VAP-implementation services.

3. The method of claim 2, further comprising providing a device client to the user for installation on the device of the user, the device client being configured to access the agent store.

4. The method of claim 1, wherein one of the VAs is an administrator virtual assistant (AVA) comprising an agent store agent for communicating with the agent store, the method further comprising creating within the AVA a plurality of first agent templates accessible by the agent store agent.

5. The method of claim 4, wherein the first agent templates comprise one or more device agent templates for creating a new agent for one or more specific devices.

6. The method of claim 5, wherein the first agent templates further comprise a universal agent template for each of an associated agent in the agent store, each universal agent template containing all of the device templates for the associated agent.

7. The method of claim 4, wherein the first agent templates comprise one or more of agent code, software installation modules, data, and metadata.

8. The method of claim 4, wherein one or more of the VAs is an agent store VA, each agent store VA comprising an agent store agent for communicating with the agent store, and each agent store VA comprising an agent template database storing a plurality of second agent templates accessible by the agent store agent of the agent store VA.

9. The method of claim 1, further comprising configuring the agent store to share the additional agents with at least one other VAP.

10. A virtual assistant platform (VAP) comprising:
a plurality of virtual assistants (VAs), each of the VAs comprising at least one agent and being configured to communicate with at least one different user; and
one or more agent stores configured to provide at least one agent to the VA of each user.

11. The VAP of claim 10, wherein the agent stores are configured to register the agents for use on the VAP.

12. The VAP of claim 10, wherein the agent stores are configured to maintain a catalog of agents available for use on the VAP.

13. The VAP of claim 10, further comprising an administrator virtual assistant (AVA) comprising:
an agent store agent for communicating with one or more of the agent stores; and
a plurality of first agent templates accessible by the agent store agent.

14. The VAP of claim 13, wherein the first agent templates comprise one or more device agent templates for creating a new agent for one or more specific devices.

15. The VAP of claim 14, wherein the first agent templates further comprise a universal agent template for each of an associated agent in the agent store, each universal agent template containing all of the device templates for the associated agent.

16. The VAP of claim 13, wherein the first agent templates comprise one or more of agent code, software installation modules, data, and metadata.

17. The VAP of claim 13, wherein one or more of the VAs is an agent store VA, each agent store VA comprising an agent store agent for communicating with the agent store, and each agent store VA comprising an agent template database storing a plurality of second agent templates accessible by the agent store agent of the agent store VA.

18. The VAP of claim 13, wherein one or more of the VAs comprises an agent template cache configured to store a copy of one or more of the first agent templates.
